(19) United States
(12) Patent Application Publication
(10) Pub. No.: US 2025/0169526 A1
(43) Pub. Date: May 29, 2025

(54) PLANT-ONLY FAT REPLACEMENT SYSTEM FOR FOODS

(71) Applicant: The Live Green Group, Inc.,, Middletown, DE (US)

(72) Inventors: Sasikanth Chemalamudi, San Fernando (CL); Priyanka Srinivas, San Fernando (CL)

(21) Appl. No.: 18/840,147

(22) PCT Filed: Feb. 22, 2023
(86) PCT No.: PCT/IB2023/051612

§ 371 Date: Aug. 21, 2024

(30) Foreign Application Priority Data
Feb. 28, 2022 (US) 63314537

(51) Int. Cl. A23L 19/00; A23D 7/005; A23L 33/115; A23L 33/15

(52) U.S. Cl. CPC A23L 19/09; A23D 7/0053; A23L 19/03; A23L 33/115; A23L 33/15

(57) ABSTRACT

The present disclosure discloses a plant-only composition for a food product. The plant-only composition comprises (i) about 5% to about 60% weight by volume of one or more fruits, (ii) about 2% to about 30% weight by volume of one or more plant-derived oils, (iii) about 5% to about 60% weight by volume of a plant-derived cream, and (iv) about 10% to about 60% weight by volume of a plant mucilage. The plant-only composition substitutes a fat-based ingredient in the food product. The fat-based ingredient may comprise any of animal fats such as butter, cheese, etc. FIG. 1

### CROSS-REFERENCE TO RELATED APPLICATIONS

This application claims priority to the U.S. Provisional Patent Application No. 63/314,537, filed Feb. 28, 2022, and PCT Provisional Patent Application No. PCT/IB2023/051612, filed Feb. 22, 2023, titled “PLANT ONLY FAT REPLACEMENT SYSTEM FOR FOODS” and is incorporated herein by reference.

### BACKGROUND

### Technical Field

Embodiments of this disclosure relates to a plant-only composition, and more particularly, relates to a plant-only composition for a food product that replaces a conventional fat ingredient in the food product. The present disclosure also relates to a food product comprising a plant-only composition. The present disclosure also relates to a fat replacement system for a food product and a process of preparing the plant-only composition.

### Description of the Related Art

Many conventional food products and, in particular, products containing fatty acids (e.g., dairy based or oil based products, such as creamers, ice creams, salad oils and dressings, etc.), contain dairy based, animal based and/or synthetic based chemical compounds or ingredients to provide desired richness, texture, taste, etc. to a food product for consumption by an individual.

Currently, the food industry uses at least 7,000 different types of synthetic or natural ingredients, such as animal or dairy based ingredients, that are highly processed to form ingredients that serve as conventional fat replacer additives. Such conventional highly processed fat replacement additives include, e.g., inulin, maltodextrin, polydextrose, milk proteins, soy proteins, and modified starches.

Given the increasing demand for plant based foods (e.g., by people interested in maintaining a vegetarian, plant-only), and given that there are several hundred thousand options of edible plant species to select, it is difficult to determine which combinations of particular plant-only ingredients to combine that would serve as a suitable fat replacement so as to avoid conventional highly processed ingredients. It would be desirable to provide a fat replacement system for foods that consists of minimally processed, plant-only ingredients while ensuring desirable flavor, texture, appearance and taste as well as the same or similar functionality of conventional fat additives for the food product to which the composition is incorporated.

Thus, there is a need for a plant-only composition for a food product to substitute the conventional fat ingredients for the food product.

### SUMMARY

In view of the foregoing, embodiments herein provide a plant-only composition for a food product. The plant-only composition comprises (i) about 5% to about 60% weight by volume of one or more fruits; (ii) about 2% to about 30% weight by volume of one or more plant-derived oils; (iii) about 5% to about 60% weight by volume of a plant-derived cream; and (iv) about 10% to about 60% weight by volume of a plant mucilage. The plant-only composition substitutes a fat ingredient in the food product.

In some embodiments, the one or more fruits comprises an avocado fruit, a custard apple, a banana, a pear puree, a muskmelon puree, an apricot, a mango puree, a dragon fruit puree, a feijoa fruit, a sapodilla, a mangosteen puree, or a combination thereof. In some embodiments, the one or more fruits comprises an avocado fruit or an avocado fruit pulp/paste. In some embodiments, the one or more fruits comprises at least 10% by weight by weight of saturated and/or unsaturated fatty acids. In some embodiments, the one or more fruits present in the plant-only composition ranges from about 10% to about 30% weight by volume of the composition.

In some embodiments, the avocado pulp/paste comprises about 67% to 78% weight by weight of pulp moisture, about 13.5% to 24% weight by weight of lipids, about 0.8% to 4.8% weight by weight of carbohydrates, 1.0% to 3.0% weight by weight of protein, about 0.8% to 1.5% weight by weight of ash, and about 1.4 to 3.0% weight by weight of fiber. In some embodiments, the avocado pulp has an energy density ranging from 140 and 228 kilocalorie (kcal). In some embodiments, the avocado pulp comprises (i) one or more vitamins comprising vitamin A, vitamin C, vitamin D, vitamin K, vitamin E and vitamin B complex and (ii) one or more minerals comprising potassium and magnesium.

In some embodiments, the one or more fruits has a freezing point of about −1.7° C., a pH ranging from 6.2 to 6.6, and an overrun of about 35% when the percentage of the one or more fruits in the plant-only composition is 30%. In some embodiments, the one or more fruits is mixed with lemon juice and/or lime juice to minimize, prevent and/or delay enzymatic browning of the avocado fruit's paste or puree. In some embodiments, an increase in the percentage/amount of the one or more fruits in the plant-only composition increases a fiber content and viscosity of the plant-only composition or the food product and decreases an acidity level and a melting rate of the plant-only composition or the food product.

In some embodiments, the one or more plant-derived oils comprises sunflower oil, flaxseed oil, olive oil, soybean oil, peas oil, sesame oil, almond oil, pistachios oil, pecans oil, walnut oil, corn oil or a combination thereof. In some embodiments, the one or more plant-derived oils comprises sunflower oil, and/or flaxseed oil. In some embodiments, the one or more plant-derived oils present in the plant-only composition ranges from about 5% to 20% weight by volume of the composition. In some embodiments, the sunflower oil comprises about 15% weight by weight of saturated acid comprising stearic acid and palmitic acid, and about 85% weight by weight of unsaturated fatty acid. The unsaturated fatty acid may comprise about 14% to 43% of oleic acids and about 44% to 75% of linoleic acids. In some embodiments, the flaxseed oil comprises fiber, protein, fatty acids comprising omega3 fatty acid and omega-6 fatty acids and alpha-linolenic acid (ALA).

In some embodiments, the flaxseed oil and the sunflower oil are combined at a weight ratio ranging from 40:60 to 60:40 to form the plant-derived oil. In some embodiments, the flaxseed oil, when combined with other ingredients of the plant-only composition, increases viscosity and texture and enhances dispersion properties of fat droplets in the food product. In some embodiments, the sunflower oil has a freezing point of about −17° C. and viscosity of about 38 centipoise (cP). In some embodiments, the flaxseed oil has a melting point of 18° C., a freezing point of about −24° C., and viscosity of about 63 centipoise (cP).

In some embodiments, the plant-derived cream comprises at least one of coconut cream, avocado fruit cream, cashew cream, bay laurel berry kernel cream, macadamia nut cream, peanut cream, Mucajá nut cream or a combination thereof. In some embodiments, the plant-derived cream comprises coconut cream. In some embodiments, the plant-derived cream present in the plant-only composition ranges from about 10% to 30% weight by volume of the composition.

In some embodiments, the plant mucilage comprises at least one of okra mucilage, mangosteen mucilage, moringa mucilage, assyrian plum mucilage, prickly pear mucilage, cassava mucilage, spinach leaves mucilage, Basella alba mucilage, Indian jujube fruit mucilage, coromandel ebony mucilage, orange fiber mucilage, tilkor fruit mucilage or a combination thereof. In some embodiments, the plant mucilage comprises okra mucilage. In some embodiments, the plant mucilage present in the plant-only composition ranges from about 10% to 40% weight by volume of the composition.

In some embodiments, the okra mucilage comprises (i) a polysaccharide rich material comprising glucose, galactose, rhamnose, glucuronic acid and galacturonic acid at concentrations between 20% and 30%, (ii) 11% of protein, (iii) 40% of carbohydrates, (iv) 10% of moisture, (v) % of ash, (vi) 0.5% of magnesium, (vii) about 3.0% of calcium, (viii) 0.1%-0.7% of potassium and (ix) 0.14%-0.18% of phosphorus. In some embodiments, the okra mucilage is prepared by cooking okra pods.

In some embodiments, the plant mucilage comprises pectin, and the pectin forms a cross-linked gel in water in the presence of calcium ions. The cross-linked gel network or polysaccharide entanglement mimics physical and sensory characteristics of emulsified fats that simulate milk/diary fats.

In some embodiments, the plant-only composition comprises about 5% to about 25% weight by volume of a carbohydrate based fat replacer. In some embodiments, the carbohydrate based fat replacer comprises tapioca starch, orange fiber, oat fiber, rice starch, potato starch, chia seeds, hemp seeds, amaranth flour, quinoa flour, or a combination thereof. In some embodiments, the carbohydrate based fat replacer comprises tapioca starch.

In some embodiments, the plant-only composition of the food product is in the form of a gel or liquid. In some embodiments, the food product comprises a frozen dessert product, a milk product or a dairy product. In some embodiments, the frozen dessert product comprises any of ice cream, or creamy products such as whipped creams or edible dipping sauces. The food product may comprise gluten free cookies, low fat burgers, muffins, sourdough bread, reduced fat pound cakes, low fat soft cheese, yogurt, low fat salad dressing, low fat mayonnaise, or biscuit.

In some embodiments, the plant-only composition comprises (i) about 10% to about 30% weight by volume of an avocado fruit, (ii) about 5% to about 20% weight by volume of sunflower oil and/or flaxseed oil, (iii) about 10% to about 30% weight by volume of coconut cream, and (iv) about 10% to about 40% weight by volume of okra mucilage. The plant-only composition substitutes a fat ingredient in the food product.

In some embodiments, the plant-only composition comprises (i) about 10% to about 30% weight by volume of an avocado fruit, (ii) about 5% to about 20% weight by volume of sunflower oil and/or flaxseed oil, (iii) about 10% to about 30% weight by volume of coconut cream, (iv) about 5% to about 25% weight by volume of tapioca starch, and (v) about 10% to about 40% weight by volume of okra mucilage. The plant-only composition substitutes a fat ingredient in the food product.

In one aspect, a food product comprising a plant-only composition is provided. The plant-only composition comprises (i) about 5% to about 60% weight by volume of one or more fruits, (ii) about 2% to about 30% weight by volume of one or more plant-derived oils, (iii) about 5% to about 60% weight by volume of a plant-derived cream, and (iv) about 10% to about 60% weight by volume of a plant mucilage. The plant-only composition substitutes a fat based ingredient in the food product.

In some embodiments, the plant-only composition present in the food product ranges from about 0.5% to 10% weight by weight of the food product. In some embodiments, the plant-only composition present in the food product ranges from about 1% to 17% weight by weight of the food product. In some embodiments, the plant-only composition present in the food product ranges from about 2% to 5% weight by weight of the food product.

In another aspect, a fat replacement system for a food product comprising a plant-only composition is provided. The plant-only composition comprises (i) about 5% to about 60% weight by volume of one or more fruits, (ii) about 2% to about 30% weight by volume of one or more plant-derived oils, (iii) about 5% to about 60% weight by volume of a plant derived cream, and (iv) about 10% to about 60% weight by volume of a plant mucilage. The plant-only composition substitutes a fat based ingredient in the food product.

In some embodiments, the one or more fruits comprises an avocado fruit or an avocado pulp/paste. In some embodiments, the one or more plant-derived oils comprises sunflower oil, and/or flaxseed oil. In some embodiments, the plant-derived cream comprises coconut cream. In some embodiments, the plant mucilage comprises an okra mucilage. In some embodiments, the plant-only composition comprises about 5% to about 25% weight by volume of a carbohydrate based fat replacer.

The plant-only composition can be used as an alternative/substitute for fat ingredient in the food products, for example, ice creams. The plant-only composition replaces conventional fat ingredients in food products that consists of minimally processed, plant-derived ingredients while ensuring desirable flavor, texture, appearance and taste as well as the same or similar functionality of conventional fat ingredients for the food product to which the composition is incorporated.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications. Further, one skilled in the relevant art will recognize that the embodiments can be practiced without one or more of the specific details or with other methods, components, materials and so forth. In other instances, wellknown structures, materials, or operations are not shown in detail to avoid obscuring the features of the embodiments. Furthermore, the features/aspects described can be practiced in various combinations, though only some of the combinations are described herein for conciseness.

### BRIEF DESCRIPTION OF THE DRAWINGS

The embodiments herein will be better understood from the following detailed description with reference to the drawings, in which.

FIG. 1 illustrates a plant-only composition for a food product according to some embodiments herein; and

FIG. 2 illustrates a flow diagram of a process of preparing a plant-only composition for a food product according to some embodiments herein.

In the drawings, like reference numbers generally indicate identical, functionally similar, and/or structurally similar elements. The drawing in which an element first appears 5 is indicated by the leftmost digit(s) in the corresponding reference number.

### DETAILED DESCRIPTION OF THE EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments.

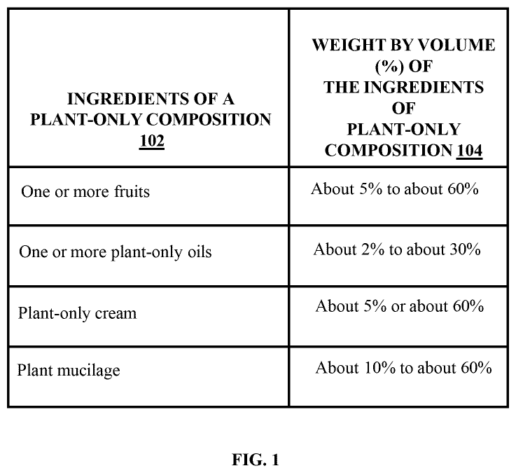

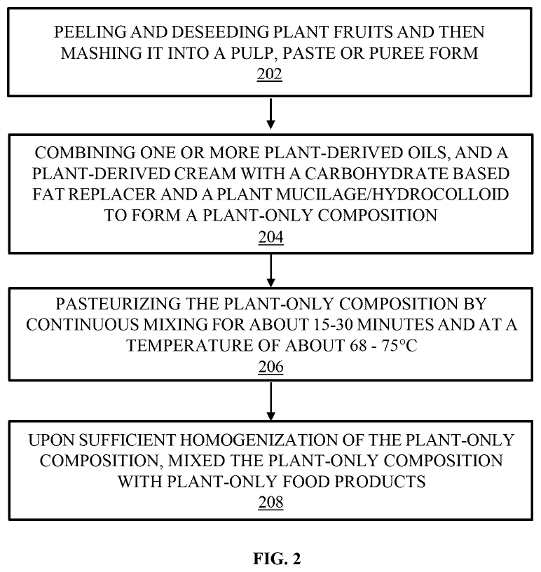

Referring now to the drawings, and more particularly to FIGS. 1 through 2, where similar reference characters denote corresponding features consistently throughout the figures, there are shown preferred embodiments.

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

The terms “comprising”, “comprises” and “comprised of” as used herein are synonymous with “including”, “includes” or “containing”, “contains”, and are inclusive or open-ended and do not exclude additional, non-recited members, elements or method steps.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

The “Plant-only” products disclosed herein, as opposed to products labeled as “plantbased.” and the like, refer to food products whose ingredients, apart from any significant amount of water added, are derived solely from sources outside of the animal kingdom, e.g., from plants, fungi, or algae. That is, “plant-only” may refer to any composition, formulation, system or a food product, that is produced, developed, or otherwise obtained directly or indirectly from one or more plants, fungi, or algae, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from animals. The US Food and Drug Administration currently has no accepted standard definition for labeling of food products described as “plant-based” although a private trade organization, the Plant Based Food Association, has proposed voluntary standards to ensure consistency when the term “plant-based” is used on a product label (i.e., it contains no animal-sourced content), and seeks to certify-through its own certification process-food products, including food product mixes, that meet this standard See https://www.plantbasedfoods.org/policy/labeling/. The terminology used on a label for a plant-based food must be truthful under FDA regulations; however, in the US, no regulatory body currently requires a company to refrain from including some amount of meat, seafood, or other animal-sourced ingredients in a “plant-based” product.

The term “food product” refers broadly to any edible good or product, raw or cooked, savory or sweet, whether intended for human or animal consumption; a food product may be edible although not intended to be consumed on its own but, rather, incorporated into a second (or third) food product that is considered a consumable. The plant-only composition disclosed herein in certain embodiments may be incorporated into or used with meat-based food products; in other embodiments it may be incorporated into or used with seafood-based food products; in still other embodiments, it may be incorporated into or used with plantbased food products. In certain preferred embodiments, the plant-only composition may be incorporated into or used with plant-only food products, including breads and other baked and fried foods.

In certain embodiments, while some of the water content of a food product may be derived from a plant source, water may also be added to the product from an external source. For example, in scenarios in which a plant-only system or composition or plant-only food product is in the form of a gel or liquid, it is further understood that water can be included as solvent or liquid carrier for the plant-only composition, system or food product, where any amount of water (some or all) within the composition, system or food product may or may not be derived from a plant source. Further, the plant-derived “agents”. “component” or “ingredients” can be fresh sourced (i.e., obtained from a particular plant source with no processing). Alternatively, the plant-derived ingredients can be minimally processed such as in ways described herein (e.g., freeze dried, pulverized or pureed, extracted from a fresh sourced portion of a plant, etc.). In some embodiments, water may be added from an external source as part of the plant-only composition (or any other plant-derived component, agent or ingredient referenced herein). In other embodiments the plant-only composition may be available in a dried form; in certain embodiments the dried form may be powdered; in other embodiments, the dried form of the plant-only composition may be in a partially powdered form; in other embodiments it may be available in a semi-liquid or gel form; in other embodiments it may be in a liquid or frozen form.

In the disclosed embodiments, apart from externally-sourced water, the plant-only food product consists entirely of ingredients derived from plants, fungi or algae, excluding any component or ingredient that is: (i) fat-based or otherwise derived from any member of the animal kingdom; and (ii) more than minimally processed; and (ii) synthetic.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, regardless of whether it is expressly described herein, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprises one or more naturally occurring chemical compounds. Selection of specific plant-derived ingredients, or specific combinations of plant-only or plant-derived ingredients, provide effective functionalities for fat replacement additives in a food product (e.g., a plant-only food product). As used herein, the term “component” or “ingredient” refers to a particular item that includes one or more chemical compounds (e.g., a food/edible parts from the plant species that comprises one or more naturally occurring chemical compounds).

In example embodiments, the plant-only food product includes a combination of components or ingredients from the plant genus that render the combination (in the amounts as indicated) particularly suitable as a fat replacement agent or composition for a food product. In such embodiments, the plant-only fat replacement system is added to other food ingredients to form a final food product formulation that requires such fat replacement composition/system. Examples of food products that utilize fat replacement additives include, without limitation, dessert like products such as ice cream, creamy products such as 5 whipped creams, edible dipping sauces, etc.

### Charaka Machine Learning (ML) Platform and the Ancestral Wisdoms Data System

In general, the selection of a specific combination of ingredients for plant-only composition/products/systems is determined using a proprietary machine learning (ML) platform, which blends ancestral wisdoms of plant nutrition with biotechnology and ML to analyze members of, primarily, the plant and fungi kingdoms, as well as other potential, natural, sources outside of the animal kingdom for the compound nature offers. The platform utilizes algorithms and includes a database with a significant number of ingredients (e.g., 50,000-100,000 ingredients) and relevant physical properties associated with such ingredients. For example, physical characterization data and information about each ingredient for some or all of the ingredients in the database include, without limitation, functional properties (e.g., emulsification properties, stabilization properties, gelling properties, fat-replacement properties, dairy replacement properties, etc.). Ayurvedic and/or other properties derived from ancestral wisdom, physicochemical properties (e.g., pH, viscosity, moisture content, density, etc.), mechanical properties (e.g., adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-derived ingredients is determined to yield an effective plant-only composition that can be used to create a desirable food product or formulation that is effective as a substitute for conventional fat ingredients in food 30 products of all kinds.

As noted, the proprietary system identifies natural alternatives, i.e., as defined, “plantderived” alternatives to synthetic, artificial, and animal-derived ingredients, and incorporates in its algorithms, among other things, ancestral or traditional knowledge from systems such as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self—one's dominant energy, also known as dosha—to prescribe the most advantageous categories of foods from which to choose for an individual's diet. Categories of Ayurvedic properties include but are not limited to Virya (hima/sheeta—cold), Vipaka (Madhura—sweet), Rasa (Madbura—sweet), and Guna (ruksa—dry: or guru—heavy). Such similar ancestral wisdoms exist in other parts of the world such as the Traditional Chinese Medicine, Amazonian rainforest ancestral wisdom which may also be used as part of Charaka. The information recommended by the proprietary Charaka system permits one to choose among hundreds of alternatives based on ingredients intended to alter a variety of properties to give optimal results for fat replacement purposes as well as physiological functionality, health, and environmental sustainability.

### Terms and Definitions:

As used in the present invention, the following terms are generally intended to have the meaning as set forth below, except to the extent that the context in which they are used indicate otherwise.

Cream: “Cream” refers to a thick yellowish-white liquid.

Protein: Proteins are large biomolecules and macromolecules that comprise one or more long chains of amino acid residues.

Fat: Fat refers to a type of lipid consisting of esters of glycerol and fatty acids or triglycerides.

Mucilage: Mucilage is a thick, gluey substance produced by plants or plant parts such as fruit, seed, or vegetable.

Lipid: Lipids are a broad group of naturally-occurring molecules which includes fats, waxes, sterols, fat-soluble vitamins, monoglycerides, diglycerides, phospholipids, and others.

Gel: A gel is a semi-solid that can have properties ranging from soft and weak to hard and tough. Gels are defined as a substantially dilute cross-linked system, which exhibits no flow when in the steady-state, although the liquid phase may still diffuse through this system.

Cross-linked gel: Cross-linked gels are a class of gels that are based on cross-linked polymeric systems.

Polysaccharide entanglement: Entanglement refers to a reticular or spherical structure formed by the cross-linking points produced in the polymer chain, or in between polymer chains, making the polymer chains unable to move normally and thus affecting the nature of the polymer.

Water holding capacity (WHC): Water-holding capacity (or water-binding capacity, or water-absorption capacity) is a measure of the total amount of water that can be absorbed per gram of a powder/composition/ingredient.

Oil absorption capacity (OAC): Oil absorption capacity is defined as the difference in the powder weight before and after its oil absorption.

Foaming capacity: The good foaming capacity of mucilage is highly associated with the flexible structure of mucilage that can reduce the surface tension. Foaming properties of proteins depend on their ability to form flexible, elastic, cohesive interfacial film which is capable of entrapping and retaining air that leads to enhanced air bubbles, resulting in excess volume of the frozen sample.

Viscosity: Viscosity is the resistance of a fluid (e.g., liquid or gas) to a change in shape or movement of neighbouring portions relative to one another. Viscosity denotes opposition to flow.

Emulsion stability: Emulsion stability is the capacity of emulsion droplets to remain dispersed without separation by creaming, coalescing, and flocculation over time.

Amount of calories: Amount of calories may provide no energy calories or structured lipid molecules which provide reduced energy calories.

pH: pH is a measure of the hydrogen ion concentration in solution and is also referred to as the degree of acidity or alkalinity.

Plant-derived: “Plant-derived” refers to ingredients extracted from a plant.

Functional properties such as the interaction with other stabilizers, emulsion stabilization structure formation, and water retention capabilities, which improves the mixture viscosity, increases melting point and reduces ice formation.

Embodiments herein provide a plant-only composition for a food product. The plant-only composition comprises (i) about 5% to about 60% weight by volume of one or more fruits; (ii) about 2% to about 30% weight by volume of one or more plant-derived oils; (iii) about 5% to about 60% weight by volume of a plant-derived cream; and (iv) about 10% to about 60% weight by volume of a plant mucilage. The plant-only composition substitutes a fat ingredient in the food product.

In some embodiments, the plant-only composition comprises (i) about 10% to about 30% weight by volume of an avocado fruit, (ii) about 5% to about 20% weight by volume of sunflower oil and/or flaxseed oil, (iii) about 10% to about 30% weight by volume of coconut cream, and (iv) about 10% to about 40% weight by volume of okra mucilage. The plant-only composition substitutes a fat ingredient in the food product.

In one aspect, a food product comprising a plant-only composition is provided. The plant-only composition comprises (i) about 5% to about 60% weight by volume of one or more fruits. (ii) about 2% to about 30% weight by volume of one or more plant-derived oils, (iii) about 5% to about 60% weight by volume of a plant-derived cream, and (iv) about 10% to about 60% weight by volume of a plant mucilage. The plant-only composition substitutes 25 a fat based ingredient in the food product.

In another aspect, a fat replacement system for a food product comprising a plant-only composition is provided. The plant-only composition comprises (i) about 5% to about 60% weight by volume of one or more fruits, (ii) about 2% to about 30% weight by volume of one or more plant-derived oils, (iii) about 5% to about 60% weight by volume of a plant-derived cream, and (iv) about 10% to about 60% weight by volume of a plant mucilage. The plant-only composition substitutes a fat based ingredient in the food product.

FIG. 1 illustrates a plant-only composition for a food product according to some embodiments herein. FIG. 1 depicts a table that includes ingredients 102 of the plant-only composition and weight 104 of the ingredients 102 of the plant-only composition. The plantonly composition comprises (i) about 5% to about 60% weight by volume of one or more fruits; (ii) about 2% to about 30% weight by volume of one or more plant-derived oils; (iii) about 5% to about 60% weight by volume of a plant-derived cream; and (iv) about 10% to about 60% weight by volume of a plant mucilage. The plant-only composition substitutes a fat ingredient in the food product.

In some embodiments, selection of a specific combination of plant-derived ingredients 102 for a plant-only fat replacement (e.g., fat substitute) composition/system is determined using a proprietary machine learning platform that utilizes algorithms and includes a database with a significant number of ingredients (e.g., 50,000-100,000 ingredients) and relevant physical properties associated with such ingredients.

For example, physical characterization data and information about each ingredient for some or all of the ingredients in the database include, without limitation, functional properties (e.g., emulsification properties, stabilization properties, gelling properties, fat-replacement properties, dairy replacement properties, etc.), ayurvedic and/or Rasa, Guna, Snigdha, Virya, Vipaka, etc. and other bolistic properties, physicochemical properties (e.g., pH, viscosity, moisture content, density, etc.), mechanical properties (e.g., adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.).

In an embodiment, the physical characterization data associated with the ingredients of the plant-only composition comprises the protein, fiber, cream, starch, sweetener, thickener, emulsifier-stabilizer system, fat, anti-freezing agent, and anti-caking agent is stored in a database. A machine learning model determines a unique combination of ingredients based on the physical characterization data to prepare the plant-only composition. The machine learning model identifies plant-derived ingredient for fat replacements based on the parameters and ranges provided in Table 1 to give the list of ingredients for each possible functionality. The “Machine learning model” refers to computer software designed to recognize patterns or behaviors based on previous experience or data.

Based upon the known properties of ingredients in the database, the desired properties for the food product or formulation, and one or more plant-derived components or ingredients is determined to yield an effective formulation that can be used as a fat replacement component or ingredient or composition for food-based products and, in particular, plant-only food products for the plant-only food industry.

Fat replacement additives are typically categorized into three categories: lipid, protein and carbohydrate based. Thus, the plant-derived ingredients are selected to fit within these categories so as to meet the requirements and specifications of achieving the same functionalities in a food product as conventional fat replacement additives. The plant-derived ingredients are minimally processed so as to maintain as much of their same properties as in their natural form. As noted herein, a combination of ingredients that provide desirable fat replacement functionalities for food products comprise one or more of the following: a fruit puree that includes at least 10% by weight saturated and/or unsaturated fatty acids (e.g., avocado fruit), one or more plant-derived oils (e.g., sunflower oil and/or flaxseed oil), a plant-derived cream (e.g., coconut cream, cashew cream, etc.), and okra mucilage. The selection of each plant-derived ingredient and its properties which render it useful in combination with one or more of the other ingredients as a fat replacement composition/system is described as follows. Water can also be added to this mixture of plantderived ingredients to provide an aqueous based system that also controls the viscosity of the composition.

In some embodiments, the one or more fruits comprises an avocado fruit, a custard apple, a banana, a pear puree, a muskmelon puree, an apricot, a mango puree, a dragon fruit puree, a feijoa fruit, a sapodilla, a mangosteen puree, or a combination thereof. In some embodiments, the one or more fruits comprises an avocado fruit or an avocado fruit pulp/paste. In some embodiments, the one or more fruits comprises at least 10% by weight by weight of saturated and/or unsaturated fatty acids. In some embodiments, the one or more fruits present in the plant-only composition ranges from about 10% to about 30% weight by weight of the composition.

Avocado fruit is particularly suitable as an ingredient in the fat replacement composition/system due to its protein and high fatty content (at least 10% by weight of saturated and unsaturated fatty acids). However, any other fruit including saturated and/or unsaturated fatty acids making up at least 10% by weight of the fruit can also be utilized in the fat replacement composition/system as an alternative to (or in combination with) avocado fruit. In particular, avocado fruit is rich in oleic acid and other monounsaturated fatty acids (MUFAs), and it also provides a creamy texture and taste feel that simulates conventional types of fats (e.g., animal fats). The MUFAs in avocado fruit can also function as natural surfactants when activated (e.g., when the avocado fruit is mashed or pulverized to form a pulp or fine paste). Avocado fruit is further nutrient and phytochemical dense, including fat soluble vitamins such as vitamins A, D, K and E. Avocado fruits contain a high total fat content (about 15% by weight of the avocado fruit), a significant portion of which are MUFAs (about 9.8% by weight), a high phytosterol content (about 57 mg/100 g), and is high in dietary fiber as well as including vitamins A, C, D, K, E and B complex and also minerals such as potassium and magnesium. Avocado pulp contains from 67 to 78% by weight (i.e., by weight of the pulp) moisture, 13.5 to 24% by weight lipids, 0.8 to 4.8% by weight carbohydrates. 1.0 to 3.0% by weight protein, 0.8 to 1.5% by weight ash, and 1.4 to 3.0% by weight fiber, and the avocado pulp further has an energy density between 140 and 228 kcal.

The avocado fruit further has a soft and mushy/creamy texture that renders it desirable as a fat replacement ingredient for a variety of different food products. Avocado fruit is provided in the system as a mashed pulp, paste or puree by first separating the flesh of the avocado from its skin and seed and then mixing (e.g., in a blender or turbo mixer) for a suitable time period to form a past or puree of a desired texture and consistency. Lemon juice and/or lime juice can also be added/mixed into the avocado paste or puree to minimize, prevent and/or delay enzymatic browning of the avocado fruit paste.

The amount of avocado provided in the fat replacement composition/system as well as any food product formed with the system will affect the viscosity of the product, where an increase in amount of avocado fruit in the product will increase the fiber and also cause an increase in viscosity of the system and product. Further, the use of avocado fruit as a fat substitute renders a food product lower in calories in comparison to conventional fat additives. For example, when providing avocado fruit as a fat substitute in an ice cream product (replacing, e.g., conventional dairy based fat components), a significant reduction in caloric content for a serving of ice cream is achievable in comparison to conventional (i.e., dairy based) ice cream products.

In some embodiments, the avocado pulp/paste comprises about 67% to 78% weight by weight of pulp moisture, about 13.5% to 24% weight by weight of lipids, about 0.8% to 4.8% weight by weight of carbohydrates, 1.0% to 3.0% weight by weight of protein, about 0.8% to 1.5% weight by weight of ash, and about 1.4 to 3.0% weight by weight of fiber. In some embodiments, the avocado pulp has an energy density ranging from 140 and 228 kilocalorie (kcal). In some embodiments, the avocado pulp comprises (i) one or more vitamins comprising vitamin A, vitamin C, vitamin D, vitamin K, vitamin E and vitamin B complex and (ii) one or more minerals comprising potassium and magnesium.

Table 1 provided herein below lists physicochemical properties as well as Ayurvedic properties of avocado fruit that renders it particularly suitable for combining with other ingredients in forming a plant-only fat replacement composition/system. For example, avocado paste provided at particular amounts within the composition can increase viscosity of the food product, lower the acidity level of the food product, and lower the melting rate of the food product (particularly useful for use in frozen dessert products like plant-only ice creams, where the overrun can also be influenced based upon amount of avocado fruit 20 provided within the system and ice cream product).

In some embodiments, the one or more fruits has a freezing point of about −1.7° C., a pH ranging from 6.2 to 6.6, and an overrun of about 35% when the percentage of the one or more fruits in the plant-only composition is 30%. In some embodiments, the one or more fruits is mixed with lemon juice and/or lime juice to minimize, prevent and/or delay enzymatic browning of the avocado fruit's paste or puree. In some embodiments, an increase in the percentage/amount of the one or more fruits in the plant-only composition increases a fiber content and viscosity of the plant-only composition or the food product and decreases an acidity level and a melting rate of the plant-only composition or the food product.

In some embodiments, the one or more plant-derived oils comprises sunflower oil, flaxseed oil, olive oil, soybean oil, peas oil, sesame oil, almond oil, pistachios oil, pecans oil, walnut oil, corn oil or a combination thereof. In some embodiments, the one or more plant-derived oils comprises sunflower oil, and/or flaxseed oil. The one or more plantderived oils having suitable fatty acids (e.g., sunflower oil, flaxseed oil, olive oil, etc.) is also provided in the plant-only fat replacement composition/system to enhance the properties of the composition. A combination of two or more plant-derived oils (e.g., sunflower oil and/or flaxseed oil) can also be provided in the plant-only fat replacement composition/system.

In some embodiments, the one or more plant-derived oils present in the plant-only composition ranges from about 5% to 20% weight by volume of the composition. In some embodiments, the sunflower oil can be provided as a liquid fat source and phytosterol source for the composition. The sunflower oil may comprise about 15% weight by weight of saturated acid comprising stearic acid and palmitic acid, and about 85% weight by weight of unsaturated fatty acid comprising about 14% to 43% of oleic acids and about 44% to 75% of linoleic acids. With this combination of the saturated and unsaturated fatty acids, the sunflower oil contributes to achieving partial coalescence in the food product as a replacement of conventional dairy fats. The sunflower oil also provides phytosterols that function as dietary supplements within the plant-only composition. As noted in the information provided in the below Table 1, higher quantities of sunflower oil in the plantonly fat replacement system provides achieves benefits in particular in reducing melting and optimizing overrun for frozen dessert based products (e.g., ice cream products).

In some embodiments, the flaxseed oil is provided in the composition to increase melting properties of the food product (e.g., frozen dessert product) as well as increasing/controlling viscosity of the food product. The flaxseed oil may comprise fiber, protein, fatty acids comprising omega-3 fatty acid and omega-6 fatty acids and alphalinolenic acid (ALA). The flaxseed oil provides a flavor profile that is nutty, sweet, oily and slightly bitter. In some embodiments, the flaxseed oil, when combined with other ingredients of the plant-only composition, increases viscosity and texture and enhances dispersion properties of fat droplets in the food product. Further properties and characteristics of the flaxseed oil, when combined with other plant-derived ingredients to form the fat replacement system, are presented in Table 1.

In some embodiments, the flaxseed oil and the sunflower oil, when used together, can be provided in the plant-only fat replacement composition/system. The flaxseed oil and the sunflower oil may be combined at a weight ratio ranging from 40:60 to 60:40, such as 50:50, to form the plant-derived oil (i.e., the same or substantially similar amounts of the flaxseed oil and the sunflower oil). In some embodiments, the sunflower oil has a freezing point of about −17° C. and viscosity of about 38 centipoise (cP). In some embodiments, the flaxseed oil has a melting point of −18° C., a freezing point of about −24° C. and viscosity of about 63 centipoise (cP).

In some embodiments, the plant-derived cream comprises at least one of coconut cream, avocado fruit cream, cashew cream, bay laurel berry kemel cream, cohune oil, macadamia nut cream, peanut cream, Mucajá nut cream or a combination thereof. In some embodiments, the plant-derived cream comprises coconut cream. In some embodiments, the plant-derived cream present in the plant-only composition ranges from about 10% to 30% weight by volume of the composition.

The plant-derived cream such as coconut cream also provides fatty acids and enhances the creamy texture, feel and taste of the plant-only fat replacement composition/system and the food product that incorporates the plant-only composition. The plant-derived cream (e.g., coconut cream) provides not only the fatty acids that mimic dairy based fats but also functions as a thickener due to its thick and creamy consistency. The coconut cream has a high lipid content due to the presence of medium chain fatty acids (MCFAs) such as lauric, linoleic and oleic acids within this component. The coconut cream can be particularly useful in the plant-only composition when the composition is incorporated within a frozen dessert product, where the coconut cream aids in the enhancement/increase in melting time and reducing overrun of the frozen dessert product.

In addition, the caloric content of the coconut cream is much lower than conventional fat ingredients. The coconut cream can be particularly useful in the fat replacement ingredient when the plant-only composition is incorporated within a frozen dessert product, where the coconut cream aids in the enhancement/increase in melting time and reducing overrun of the frozen dessert product. In an example, the plant-derived creams are made with creams with at least 16% of fats. In some embodiments, the cashew cream has an emulsion stability of up to 96%.

In some embodiments, the plant-only composition comprises about 5% to about 25% weight by volume of a carbohydrate based fat replacer. In some embodiments, the carbohydrate based fat replacer comprises tapioca starch, orange fiber, oat fiber, rice starch, potato starch, chia seeds, hemp seeds, amaranth flour, quinoa flour, or a combination thereof. In some embodiments, the carbohydrate based fat replacer comprises tapioca starch.

In some embodiments, the plant mucilage comprises at least one of okra mucilage, mangosteen mucilage, moringa mucilage, assyrian plum mucilage, prickly pear mucilage, cassava mucilage, spinach leaves mucilage, Basella alba mucilage, Indian jujube fruit mucilage, coromandel ebony mucilage, orange fiber mucilage, tilkor fruit mucilage or a combination thereof. In some embodiments, the plant mucilage comprises okra mucilage. In some embodiments, the plant mucilage present in the plant-only composition ranges from about 10% to 40% weight by volume of the composition.

In some embodiments, the plant mucilage comprises pectin, and the pectin forms a cross-linked gel in water in the presence of calcium ions. The cross-linked gel network or polysaccharide entanglement mimics physical and sensory characteristics of emulsified fats that simulate milk/diary fats (e.g., fats in frozen dessert products such as ice cream).

In some embodiments, the okra mucilage comprises (i) a polysaccharide rich material comprising glucose, galactose, rhamnose, glucuronic acid and galacturonic acid at concentrations between 20% and 30%, (ii) 11% of protein, (iii) 40% of carbohydrates, (iv) 10% of moisture, (v) 10% of ash, (vi) 0.5% of magnesium, (vii) about 3.0% of calcium, (viii) 0.1%-0.7% of potassium and (ix) 0.14%-0.18% of phosphorus.

In some embodiments, the okra mucilage is prepared by cooking okra pods. In some embodiments, any conventional or other suitable process can be used to convert the okra pods as disclosed above to a mucilage. The okra mucilage can be provided in the plant-only fat replacement composition/system due to its polysaccharide content. The okra mucilage can be extracted by any number of conventionally known methods. For example, the okra pods can be cooked to produce a viscous and slimy mucilage, which comprises a polysaccharide-rich hydrocolloid. The okra polysaccharides comprise acidic polysaccharides composed of glucose, galactose, rhamnose, galacturonic acid and glucuronic acid. The methods for forming okra mucilage can directly influence its physicochemical characteristics and biological activity such that polysaccharides in the mucilage contribute to providing properties for the composition like water holding and binding capacity. The okra mucilage further provides benefits for frozen dessert products such as ice cream (e.g., reducing overrun in the food product).

In some embodiments, the solubility of plant mucilage improves with increasing temperatures. Another property of plant mucilage is its ability to retain water (i.e., Water holding capacity, WHC), which is dependent on capillary action and the amount of protein components present in the mucilage.

In some embodiments, the okra mucilage has a foaming capacity of 30 to 65% of 1% weight by volume (w/v). In some embodiments, the concentration of mucilage increases, when its viscosity increases. The okra mucilage may act as fat substitutes which maintain the palatability of foods as they can reproduce the texture and mouthfeel of fat. Further, lower pH values of mucilage are likely to improve protein recovery due to protein solubilization. Although, below 3 pH, the action of acid may result in a lower protein yield due to its hydrolysis. The mucilage has good oil absorption capacity which improves the texture of the food product. The fruit or extracted mucilage has good oil binding capacity due to presence of monopolar molecules, therefore, it can trap higher amounts of oil particles and also prevent oil and the loss of flavor from food products.

The unique combination of ingredients and their properties that form the plant-only fat replacement system are summarized in Table 1 as follows:

TABLE 1
Ingredients in the plant-only fat replacement system and their properties

| | | Physicochemical | Ayurvedic |
|---|---|---|---|
| Ingredient | Functionality | properties | properties |
| Avocado | Fats like | Freezing point- | Rasa: Titka |
| etc., (Fruit | Monounsaturated | 28.86 Fahrenheit | (Bitter) |
| puree) | Fatty Acid (MUFA) | Viscosity- The greater | Guna: Guru |
| | in avocado fruit are | the concentration of | (heavy) |
| | carriers of flavor | avocado paste in the | Snigdha |
| | and shapes the | ice cream (e.g., food | (oil/smooth) |
| | creamy/greasy | product) results in an | Virya: Hima |
| | structure of plant- | increase in overall | (Cold) |
| | only ice cream (e.g., | viscosity. | Vipaka: Tikta, |
| | food product). Since | Overrun - It is | Madura |
| | avocado fruits are | inversely proportional | |
| | used in this as a fat | to the concentration of | |
| | substitute. The | avocado paste. When | |
| | portion of 90 gram | the paste is at a | |
| | ice cream includes | concentration of 30% | |
| | only 109 kcal, which | then the overrun is | |
| | is way less than | 35%. | |
| | conventional dairy | pH - avocado paste | |
| | ice creams. | lowers the acidity | |
| | | level of the ice cream. | |
| | | The acidity level of | |
| | | avocado is pH 6.2-6.6. | |
| | | Melting rate - higher | |
| | | concentration of | |
| | | avocado paste results | |
| | | in the increase of | |
| | | viscosity of the ice | |
| | | cream mixture which | |
| | | resulted in a decrease | |
| | | in the melting rate. | |
| Sunflower | Sunflower oil | Freezing point: −17° C. | Rasa: Madhura |
| Oil etc., | includes a liquid fat | Viscosity: The | (sweet) |
| (Vegetable | source constituting | kinematic viscosity of | Guna: Laghu |
| Phytosterol | 85% unsaturated | sunflower oil 38 cP. | (Easy to digest), |
| and | fatty acids (linoleic, | Overrun: Optimum | Snigdha (oily), |
| Polyunsaturated | oleic, stearic, and | overrun is achieved | Guru (heavy) |
| fatty acids, | palmitic acid). | when the liquid fat | Virya: |
| PUFA, source) | They contribute to | replacer constitutes to | Sheeta/Hima |
| | achieving partial | 20 to 40%. Also, | (Cold) |
| | coalescence in ice | proper stabilization of | Vipaka: Madhura |
| | cream, which is a | the composition is | (Sweet) |
| | main factor in the | achieved on addition | |
| | replacement of | of the liquid fat source. | |
| | dairy fat with plant- | Higher quantity leads | |
| | only fat. | to oil | |
| | | wetting/spreading | |
| | | where the fat globules | |
| | | spread at the air | |
| | | interface, causing | |
| | | thinning of the lamella | |
| | | between the bubbles. | |
| | | This collapses the air | |
| | | phase and | |
| | | destabilization occurs. | |
| | | All these cause a final | |
| | | impact with decreased | |
| | | overrun. | |
| | | Meltdown resistance: | |
| | | Optimum Liquid fat | |
| | | contributes to reduce | |
| | | melting of ice cream. | |
| Flaxseed | Flaxseed oil is used | Melting point- | Rasa: Madhura |
| Oil etc., | as a source for | −18° C. | (Sweet) |
| (Vegetable | Omega-3 in icecream | Freezing point- −11 | Tikta (Bitter) |
| Phytosterols | and as a partial | Fahrenheit (−24° C.) | Guna: Guru |
| and PUFA | substitute for milk fat | Viscosity- 63 Cp | (Heavy) |
| source) | in preparing the | Physiochemical | Snigdha (Smooth) |
| | mixture. The results | components- | Virya: Ushna |
| | show that the | Flaxseed oil contains | (Hot) |
| | increase in melting | both omega-3 and | Vipaka: Katu |
| | property increases | omega-6 fatty acids, | (Pungent) |
| | rates of replacement, | which are needed for | |
| | while the overrun | health. Flaxseed oil | |
| | and viscosity | contains the essential | |
| | increase rates of | fatty acid alpha- | |
| | replacement, | linolenic acid (ALA), | |
| | compared with a | which the body | |
| | sample comparison. | converts into | |
| | However, there is a | eicosapentaenoic acid | |
| | decrease in | (EPA), and | |
| | cholesterol while | docosahexaenoic | |
| | increased peroxide | acid (DHA), which is | |
| | value and acidity | the omega-3 fatty | |
| | during extended | acids found in fish | |
| | storage amounting to | oil. | |
| | one day and (7 and | | |
| | 14) days which | | |
| | proves that flaxseed | | |
| | oil can be used as a | | |
| | fat replacer in ice | | |
| | creams. This | | |
| | carbohydrate-based | | |
| | fat replacer has | | |
| | surface structure | | |
| | similar to emulsified | | |
| | fat which can | | |
| | withstand | | |
| | interactions | | |
| | between particles | | |
| | within ice cream | | |
| | microstructure. | | |
| Coconut | Coconut cream has | Overrun: | Rasa: Madhur |
| cream etc., | a high lipid content | Incorporation of | (Sweet) |
| (medium- | due to presence of | coconut cream in the | Guna: |
| chain fatty | medium chain fatty | ice cream reduced | Hima/Sheeta |
| acids | acids (MCFA's) | the overrun. | (Cold) |
| (MCFAs)/ | such as lauric, | Melting time: 12 | Snigdha(Oily) |
| medium | linoleic and oleic | grams (g) ice cream | Virya: |
| chain | acids. | made with coconut | Hima/Sheeta |
| triglycerides | | pulp presented a | (Cold) |
| (MCTs)) | | melting time of 12 | Vipaka: Madhura |
| | | minutes. | (Sweet) |
| Tapioca | Tapioca starch | Melting point- | Rasa: Madhura |
| Starch | granules have the | 169.2° C. | (Sweet) |
| (Carbohydrate | ability to disperse | Water Holding | Lavana (Salty) |
| based fat | individually in a | Capacity: 43.67% | Guna: Virya: |
| replacer) | form that is similar | Viscosity- 851 | Hima/Sheeta |
| | to that of emulsion | Centipoise | (Cold) |
| | droplets. This | Effect on viscosity: | Vipaka: Madhura |
| | dispersion aids in | The amylopectin | (Sweet) |
| | adding distinctive | present helps in | |
| | textural and sensory | increasing the | |
| | qualities and creamy | viscosity. Also, it | |
| | mouthfeel. These | restricts the crystal | |
| | starch granules | growth during | |
| | mimic interfacial | storage. | |
| | interaction and | Effect on melting | |
| | hydrophobicity of | resistance: The | |
| | lipids and fats in | gelatinized starch | |
| | food | contributes to the | |
| | products/systems. | higher melting | |
| | The water holding | resistance. | |
| | capacity of the | Effect on overrun: | |
| | gelatinised tapioca | Optimized overrun is | |
| | starch increases | recorded due to the | |
| | viscosity and also | gelatinized starch. | |
| | aids in providing | | |
| | mouthfeel of fat, as | | |
| | well as the | | |
| | spreadability. | | |
| Okra | Okra pods, when | Melting resistance: | Rasa: Madhura |
| Mucilage | cooked, produce a | Increasing amounts | (Sweet), |
| etc., (Plant | viscous and slimy | of okra gum | Kashaya |
| Hydrocolloid) | mucilage, which is a | increases the melting | (astringent) |
| | polysaccharide-rich | rate in ice cream | Guna: |
| | hydrocolloid. The | Overrun: Increasing | Guru(heavy) |
| | okra polysaccharides | amounts of okra gum | Snigdha (oily), |
| | contain acidic | reduces the overrun | Picchila (sticky) |
| | polysaccharides | in ice cream | Virya: Sheeta |
| | composed of | Viscosity: Addition | (cold) |
| | glucose, galactose, | of okra gum | Vipaka: Madhura |
| | rhamnose, | increases the | (sweet) |
| | galacturonic acid | viscosity of ice | |
| | and glucuronic | cream | |
| | acid. Okra | | |
| | mucilage contains | | |
| | pectin, and these | | |
| | pectin components | | |
| | can build a cross- | | |
| | linked gel in water | | |
| | in the presence of | | |
| | calcium ions. | | |
| | These gel cross- | | |
| | linked networks or | | |
| | polysaccharide | | |
| | entanglements, | | |
| | mimic the physical | | |
| | and sensory | | |
| | characteristics of | | |
| | emulsified fats in | | |
| | ice creams. | | |

Each ingredient can be provided in a suitable amount to provide fat replacement functionality in a particular type of food product. For example, a fruit including suitable fat content (e.g., avocado) can be provided in an amount from about 5% to about 60% or greater (e.g., from about 10% to about 30%) by total weight of the plant-only fat replacement composition/system, each oil (e.g., each of sunflower oil and flaxseed oil) can be provided in an amount from about 2% to about 30% or greater (e.g., from about 5% to about 20%) by total weight of the plant-only fat replacement system, a plant-derived oil (e.g., coconut oil) can be provided in an amount from about 5% to about 60% or greater (e.g., from about 10% to about 30%) by total weight of the plant-only fat replacement composition/system, and okra mucilage can be provided in an amount from about 10% to about 60% or greater (e.g., from about 10% to about 40%) by total weight of the plant-only fat replacement composition/system.

A particularly effective combination of plant-derived ingredients for the plant-only fat replacement composition/system, which includes those previously described herein, is 15 set forth in Table 2 as follows:

TABLE 2
Liquid based ingredients for plant-only
fat replacement system/composition

| | % Weight/Volume |
|---|---|
| Ingredient | (w/v) |
| Fruit puree (e.g., Avocado fruit) | 10-30 |
| Vegetable phytosterols (e.g., | 5-20 |
| Sunflower Oil and/or | |
| Flaxseed Oil) | |
| MCFA source (e.g., Coconut Cream) | 10-30 |
| Plant Hydrocolloid/Mucilage | 10-40 |
| (e.g., Okra Mucilage) | |

In some embodiments, as provided in the table 2, the plant-only composition comprises (i) about 10% to about 30% weight by volume of an avocado fruit, (ii) about 5% to about 20% weight by volume of sunflower oil and/or flaxseed oil, (iii) about 10% to about 30% weight by volume of coconut cream, and (iv) about 10% to about 40% weight by volume of okra mucilage. The plant-only composition substitutes a fat ingredient in the food product.

Another effective combination of plant-derived ingredients for the plant-only fat replacement composition/system, which includes those previously described herein, is set 10 forth in Table 3 as follows:

TABLE 3
Liquid based ingredients for plant-only
fat replacement composition/system

| | % Weight/Volume |
|---|---|
| Ingredient | (w/v) |
| Fruit puree (e.g., Avocado fruit) | 10-30 |
| Vegetable phytosterols (e.g., | 5-20 |
| Sunflower Oil and/or | |
| Flaxseed Oil) | |
| MCFA source (e.g., Coconut Cream) | 10-30 |
| Carbohydrate-based fat replacer | |
| (e.g., Tapioca Starch) | 5-25 |
| Plant Hydrocolloid/Mucilage | |
| (e.g., Okra Mucilage) | 10-40 |

In some embodiments, as provided in the table 3, the plant-only composition comprises (i) about 10% to about 30% weight by volume of an avocado fruit, (ii) about 5% to about 20% weight by volume of sunflower oil and/or flaxseed oil, (iii) about 10% to about 30% weight by volume of coconut cream, and (iv) about 5% to about 25% weight by volume of tapioca starch, (v) about 10% to about 40% weight by volume of okra mucilage. The plant-only composition substitutes a fat ingredient in the food product.

The plant-only fat replacement system can be formed by combining and mixing the ingredients in any suitable manner, any suitable order and any suitable combination(s) so as to obtain a uniform, homogenous mixture. The composition can also be combined and mixed with any other food ingredients to form a food product (e.g., plant-only food product) in which the composition functions as a fat substitute for the food product.

Table 4 provides parameter ranges and the functionalities associated with each plant derived ingredient of the plant-only fat replacement composition/system:

TABLE 4
Parameter ranges and the functionalities associated
with each plant-derived ingredient:

Functionality of plant-

| derived ingredients | Parameters and ranges | | | |
|---|---|---|---|---|
| Fruit puree | Flow behavior | It is non- | | |
| | index is less | Newtonian | | |
| | than 1, i.e., | | | |
| | shear thinning | | | |
| | (n < 1). | | | |
| Vegetable | HLB score: | Emulsion | Fat content: | |
| phytosterols & | For vegetable | stability: | >16% | |
| PUFA source(s) | oils, the HLB | 3070% | | |
| | score is | | | |
| | 6 (required) | | | |
| MCFA | Fat | pH: 3-6 | Emulsion | |
| sources | percentage: | | stability: | |
| | 16-50% | | 50-96% | |
| Carbohydrate | No energy | Emulsion | Water | Peak/Maximum |
| based fat | calories or | stability: | holding | viscosity: 0.1 |
| replacer | structured | 60-99% | capacity %: | and 0.9 Pas, at |
| | lipid | | 43 to 300+% | a shear rate of |
| | molecules | | | 115 s−1 |
| | which | | | |
| | provide, | | | |
| | reduced | | | |
| | energy | | | |
| | calories. | | | |
| Plant | Emulsion | Calories: | Oil | pH: |
| hydrocolloid/ | stability: | Low | Absorption | More than 3 |
| Mucilage | 42.22 to | | capacity: | |
| | 70% or more. | | More than 5% | |

The plant-only fat replacement composition/system can be provided in a food product. e.g., in a frozen dessert product (e.g., ice cream), a milk product or other dairy product in an amount of about 0.5% to about 10% weight by weight of the food product, such as from about 1% to about 17% weight by weight of the food product, or from about 2% to about 5% weight by weight of the food product. In some embodiments, the frozen dessert product comprises any of ice cream, or creamy products such as whipped creams or edible dipping sauces. The food product may comprise gluten free cookies, low fat burgers, muffins, sourdough bread, reduced fat pound cakes, low fat soft cheese, yogurt, low fat salad dressing, low fat mayonnaise, or biscuit.

In some embodiments, a food product comprising a plant-only composition is provided. The plant-only composition comprises (i) about 5% to about 60% weight by volume of one or more fruits, (ii) about 2% to about 30% weight by volume of one or more plant-derived oils, (iii) about 5% to about 60% weight by volume of a plant-derived cream, and (iv) about 10% to about 60% weight by volume of a plant mucilage. The plant-only composition substitutes a fat based ingredient in the food product.

In some embodiments, a fat replacement system for a food product comprising a plant-only composition is provided. The plant-only composition comprises (i) about 5% to about 60% weight by volume of one or more fruits, (ii) about 2% to about 30% weight by volume of one or more plant-derived oils, (iii) about 5% to about 60% weight by volume of a plant-derived cream, and (iv) about 10% to about 60% weight by volume of a plant mucilage. The plant-only composition substitutes a fat based ingredient in the food product.

In some embodiments, the one or more fruits comprises an avocado fruit or an avocado pulp/paste. In some embodiments, the one or more plant-derived oils comprises sunflower oil, and/or flaxseed oil. In some embodiments, the plant-derived cream comprises coconut cream. In some embodiments, the plant mucilage comprises an okra mucilage. In some embodiments, the plant-only composition comprises about 5% to about 25% weight by volume of a carbohydrate based fat replacer.

### Ingredient Preparation Method:

Avocado fruit pulp/paste: Avocado fruit is provided in the composition as a mashed pulp, paste or puree by first separating the flesh of the avocado fruit from its skin and seed and then mixing (e.g., in a blender or a turbo mixer) for a suitable time period to form a past or puree of a desired texture and consistency.

Sunflower oil: Clean and dehulled seeds are ground into a coarse meal followed by size reduction in finer particles by rollers. This fine meal is heated to enable oil extraction. The heated meal is pressed in a screw press with pressure of 60 kilopascals (kps) and more. The squeezed sunflower oil is collected and finally deodorized in a vacuum at 225° C.

Flaxseed oil: Flaxseeds are cleaned, dried for four hours at 105° C. in an oven, and then ground into a powder using a mortar and pestle. A round-bottomed flask, a water condenser, and the extraction thimble are added to a soxhlet extraction apparatus together with the ground material. Petroleum ether (i.e., 60-80° C.) is used to extract oil seeds for 8 hours; following extraction, petroleum ether is withdrawn under reduced pressure. The flaxseed oil is then kept in storage.

Coconut cream: After the ripe coconuts are husked and cut in half, the water is drained. After being shredded in a motorized rotary grater to separate the white meat from the shell, it is then blended at high speed with an equivalent volume of water (w/w). The cream is subsequently obtained by pressing the slurry through two layers of cheesecloth. Optionally, the coconut cream is prepared by mixing the shredded coconut with water, and homogenizing it. Further, the water layer is filtered out to retain the creamy layer.

Tapioca starch: Tapioca pregelatinized starch is produced from cassava, a root vegetable of the cassava shrub. The cassava root is washed and pulp is made. A starchy liquid is extracted from the wet pulp and dried to produce tapioca starch.

Okra mucilage: About 100 grams (g) sliced and dried okra is dissolved in 3000 milliliter (ml) distilled water. Then, it is heated in a water bath with continuous stirring for 1 hour (hr) at 60° C. The concentrated solution is then filtered through a muslin cloth and cooled to room temperature. The filtered mucilage is dried in an oven at 45° C. The hard okra mucilage cake is ground into a fine powder and passed through a sieve.

FIG. 2 illustrates a flow diagram of a process of preparing a plant-only composition for a food product according to some embodiments herein. At a step 202, fresh plant fruits (e.g., avocado fruits) are peeled and/or deseeded and then mashed into a pulp, paste or puree form and are uniformly mixed in a 50:50 weight ratio. In some embodiments, the combined fruit pulp mixture is immersed in lemon juice and/or lime juice for about 15 minutes to minimize, prevent and/or delay enzymatic browning of the fruit's paste or puree. In some embodiments, the pulp is then separated from the lemon and/or lime juice and water may be added as necessary. At a step 204, one or more plant-derived oils, i.e., plant-only fat sources like vegetable phytosterols & Polyunsaturated fatty acids (PUFAs) (e.g., sunflower oil and flaxseed oil) and a plant-derived cream, i.e., medium-chain fatty acids (MCFA), (e.g., coconut cream) are combined with a carbohydrate based fat replacer (e.g., tapioca starch), and a plant mucilage/hydrocolloid (e.g., okra mucilage), at ambient temperature and mixed together in a suitable blender or turbo mixer to form a plant-only composition.

At a step 206, the plant-only composition is then pasteurized by continuous mixing for about 15-30 minutes and at a temperature of about 68-75° C. In some embodiments, additional plant-derived ingredients are then added to the composition, with further mixing and homogenization of the ingredients via blender or turbo mixer. At a step 208, upon sufficient homogenization of the plant-only composition, the composition is further mixed with plant-only food products, for e.g., in an ice cream machine that churns the composition while it is being cooled until a temperature of about −8° C. is reached. In some embodiments, a wide range of plant-only frozen dessert products can be formed with essential plant-derived ingredients and composition as described herein.

In some embodiments, the fruits comprises an avocado fruit or an avocado pulp/paste. The one or more plant-derived oils may comprise sunflower oil, flaxseed oil, olive oil or a combination thereof. The plant-derived cream may comprise at least one of coconut cream, avocado fruit cream, cashew cream, or a combination thereof. The plant mucilage may comprise an okra mucilage.

While specific embodiments of the present disclosure have been shown and described in detail to illustrate the inventive principles, it will be understood that the present disclosure may be embodied otherwise without departing from such principles.

While considerable emphasis has been placed herein on the specific features of the preferred embodiment, it will be appreciated that many additional features can be added and that many changes can be made in the preferred embodiment without departing from the principles of the present disclosure. These and other changes in the preferred embodiment of the present disclosure will be apparent to those skilled in the art from the present disclosure herein, whereby it is to be distinctly understood that the foregoing descriptive matter is to be interpreted merely as illustrative of the present disclosure and not as a limitation.

The use of the expression “at least” or “at least one” suggests the use of one or more elements or components, as the use may be in the embodiment of the present disclosure to achieve one or more of the desired objects or results. While certain embodiments of the present disclosure have been described, these embodiments have been presented by way of example only, and are not intended to limit the scope of the present disclosure. Variations or modifications to the formulation of this present disclosure, within the scope of the present disclosure, may occur to those skilled in the art upon reviewing the present disclosure herein. 20 Such variations or modifications are well within the spirit of this present disclosure.

Reference throughout this specification to “some embodiments”, “an embodiment”, or similar language means that a particular feature, structure, or characteristic described in connection with the embodiment is included in at least one embodiment of the present disclosure. Thus, appearances of the phrases “in some embodiments”, “in an embodiment” and similar language throughout this specification may, but do not necessarily, all refer to the same embodiment.

It should be understood that the figures shown above highlighting the functionality and advantages of the present disclosure are presented for example purposes only. The present disclosure is sufficiently flexible and configurable, such that it may be utilized in 30 ways other than that shown in the figures.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A plant-only composition for a food product, comprising:
about 5% to about 60% weight by volume of one or more fruits;
about 2% to about 30% weight by volume of one or more plant-derived oils; about 5% to about 60% weight by volume of a plant-derived cream; and
about 10% to about 60% weight by volume of a plant mucilage, wherein the plant-only composition substitutes a fat ingredient in the food product.

2. The plant-only composition of claim 1, wherein the one or more fruits comprises an avocado fruit, a custard apple, a banana, a pear puree, a muskmelon puree, an apricot, a mango puree, a dragon fruit puree, a feijoa fruit, a sapodilla, a mangosteen puree, or a combination thereof.

3. The plant-only composition of claim 1, wherein the one or more fruits comprises an avocado fruit or an avocado fruit pulp/paste.

4. The plant-only composition of claim 1, wherein the one or more fruits comprises at least 10% by weight by weight of saturated and/or unsaturated fatty acids.

5. The plant-only composition of claim 1, wherein the one or more fruits present in the plant-only composition ranges from about 10% to about 30% weight by volume of the composition.

6. The plant-only composition of claim 3, wherein the avocado pulp/paste comprises about 67% to 78% weight by weight of pulp moisture, about 13.5% to 24% weight by weight of lipids, about 0.8% to 4.8% weight by weight of carbohydrates, 1.0% to 3.0% weight by weight of protein, about 0.8% to 1.5% weight by weight of ash, and about 1.4 to 3.0% weight by weight of fiber.

7. The plant-only composition of claim 3, wherein the avocado pulp has an energy density ranging from 140 and 228 kilocalorie (kcal).

8. The plant-only composition of claim 3, wherein the avocado pulp comprises (i) one or more vitamins comprising vitamin A, vitamin C, vitamin D, vitamin K, vitamin E and vitamin B complex and (ii) one or more minerals comprising potassium and magnesium.

9. The plant-only composition of claim 1, wherein the one or more fruits has a freezing point of about −1.7° C., a pH ranging from 6.2 to 6.6, and an overrun of about 35% when the percentage of the one or more fruits in the plant-only composition is 30%.

10. The plant-only composition of claim 1, wherein the one or more fruits is mixed with lemon juice and/or lime juice to minimize, prevent and/or delay enzymatic browning of the avocado fruit's paste or puree.

11. The plant-only composition of claim 1, wherein an increase in the percentage/amount of the one or more fruits in the plant-only composition increases a fiber content and viscosity of the plant-only composition or the food product and decreases an acidity level and a melting rate of the plant-only composition or the food product.

12. The plant-only composition of claim 1, wherein the one or more plant-derived oils comprises sunflower oil, flaxseed oil, olive oil, soybean oil, peas oil, sesame oil, almond oil, pistachios oil, pecans oil, walnut oil, corn oil or a combination thereof.

13. The plant-only composition of claim 1, wherein the one or more plant-derived oils comprises sunflower oil, and/or flaxseed oil.

14. The plant-only composition of claim 1, wherein the one or more plant-derived oils present in the plant-only composition ranges from about 5% to 20% weight by volume of the composition.

15. The plant-only composition of claim 13, wherein the sunflower oil comprises about 15% weight by weight of saturated acid comprising stearic acid and palmitic acid, and about 85% weight by weight of unsaturated fatty acid, wherein the unsaturated fatty acid comprises about 14% to 43% of oleic acids and about 44% to 75% of linoleic acids.

16. The plant-only composition of claim 13, wherein the flaxseed oil comprises fiber, protein, fatty acids comprising omega-3 fatty acid and omega-6 fatty acids and alpha-linolenic acid (ALA).

17. The plant-only composition of claim 13, wherein the flaxseed oil and the sunflower oil are combined at a weight ratio ranging from 40:60 to 60:40 to form the plant-derived oil.

18. The plant-only composition of claim 13, wherein the flaxseed oil, when combined with other ingredients of the plant-only composition, increases viscosity and texture and enhances dispersion properties of fat droplets in the food product.

19. The plant-only composition of claim 13, wherein the sunflower oil has a freezing point of about −17° C. and viscosity of about 38 centipoise (cP).

20. The plant-only composition of claim 13, wherein the flaxseed oil has a melting point of −18° C., a freezing point of about −24° C., and viscosity of about 63 centipoise (cP).

21. The plant-only composition of claim 1, wherein the plant-derived cream comprises at least one of coconut cream, avocado fruit cream, cashew cream, bay laurel berry kernel cream, macadamia nut cream, peanut cream, Mucajá nut cream or a combination thereof.

22. The plant-only composition of claim 1, wherein the plant-derived cream comprises coconut cream.

23. The plant-only composition of claim 1, wherein the plant-derived cream present in the plant-only composition ranges from about 10% to 30% weight by volume of the composition.

24. The plant-only composition of claim 1, wherein the plant mucilage comprises at least one of okra mucilage, mangosteen mucilage, moringa mucilage, assyrian plum mucilage, prickly pear mucilage, cassava mucilage, spinach leaves mucilage, Basella alba mucilage, Indian jujube fruit mucilage, coromandel ebony mucilage, orange fiber mucilage, tilkor fruit mucilage or a combination thereof.

25. The plant-only composition of claim 1, wherein the plant mucilage comprises okra mucilage.

26. The plant-only composition of claim 1, wherein the plant mucilage present in the plant-only composition ranges from about 10% to 40% weight by volume of the composition.

27. The plant-only composition of claim 25, wherein the okra mucilage comprises (i) a polysaccharide rich material comprising glucose, galactose, rhamnose, glucuronic acid and galacturonic acid at concentrations between 20% and 30%, (ii) 11% of protein, (iii) 40% of carbohydrates, (iv) 10% of moisture, (v) 10% of ash, (vi) 0.5% of magnesium, (vii) about 3.0% of calcium, (viii) 0.1%-0.7% of potassium and (ix) 0.14%-0.18% of phosphorus.

28. The plant-only composition of claim 25, wherein the okra mucilage is prepared by cooking okra pods.

29. The plant-only composition of claim 1, wherein the plant mucilage comprises pectin, and wherein the pectin forms a cross-linked gel in water in the presence of calcium ions, wherein the cross-linked gel network or polysaccharide entanglement mimics physical and sensory characteristics of emulsified fats that simulate milk/diary fats.

30. The plant-only composition of claim 1, wherein the plant-only composition comprises about 5% to about 25% weight by volume of a carbohydrate based fat replacer.

31. The plant-only composition of claim 30, wherein the carbohydrate based fat replacer comprises tapioca starch, orange fiber, oat fiber, rice starch, potato starch, chia seeds, hemp seeds, amaranth flour, quinoa flour, or a combination thereof.

32. The plant-only composition of claim 30, wherein the carbohydrate based fat replacer comprises tapioca starch.

33. The plant-only composition of claim 1, wherein the food product comprises a frozen dessert product, a milk product or a dairy product, wherein the frozen dessert product comprises any of ice cream, or creamy products such as whipped creams or edible dipping sauces.

34. The plant-only composition of claim 1, wherein the plant-only composition comprises about 10% to about 30% weight by volume of an avocado fruit;
about 5% to about 20% weight by volume of sunflower oil and/or flaxseed oil; about 10% to about 30% weight by volume of coconut cream; and
about 10% to about 40% weight by volume of okra mucilage, wherein the plant-only composition substitutes a fat ingredient in the food product.

35. The plant-only composition of claim 30, wherein the plant-only composition comprises
about 10% to about 30% weight by volume of an avocado fruit;
about 5% to about 20% weight by volume of sunflower oil and/or flaxseed oil; about 10% to about 30% weight by volume of coconut cream;
about 5% to about 25% weight by volume of tapioca starch; and
about 10% to about 40% weight by volume of okra mucilage, wherein the plant-only composition substitutes a fat ingredient in the food product.

36. A food product comprising a plant-only composition, wherein the plant-only composition comprises
about 5% to about 60% weight by volume of one or more fruits;
about 2% to about 30% weight by volume of one or more plant-derived oils; about 5% to about 60% weight by volume of a plant-derived cream; and
about 10% to about 60% weight by volume of a plant mucilage, wherein the plant-only composition substitutes a fat ingredient in the food product.

37. The food product of claim 36, wherein the plant-only composition present in the food product ranges from about 0.5% to 10% weight by weight of the food product.

38. The food product of claim 36, wherein the plant-only composition present in the food product ranges from about 1% to 17% weight by weight of the food product.

39. The food product of claim 36, wherein the plant-only composition present in the food product ranges from about 2% to 5% weight by weight of the food product.

40. A fat replacement system for a food product comprising a plant-only composition, wherein said plant-only composition comprises:
about 5% to about 60% weight by volume of one or more fruits;
about 2% to about 30% weight by volume of one or more plant-derived oils; about 5% to about 60% weight by volume of a plant-derived cream; and
about 10% to about 60% weight by volume of a plant mucilage, wherein the plant-only composition substitutes a fat ingredient in the food product.
